(19) United States
(12) Patent Application Publication
(10) Pub. No.: US 2008/0020708 A1
(43) Pub. Date: Jan. 24, 2008

(54) Blue tooth wireless earphone and wireless network phone supported as extension thereof

(75) Inventors: Cheng-Chieh Ku, Hsin-Chu (TW); Chung-I Lee, Hsin-Chu (TW); Albert Chen, Hsin-Chu (TW)

Correspondence Address: BIRCH STEWART KOLASCH & BIRCH, PO BOX 747, FALLS CHURCH, VA, 22040-0747, US

(73) Assignee: Integrated System Solution Corp.

(21) Appl. No.: 11/802,878

(22) Filed: May 25, 2007

(30) Foreign Application Priority Data
Jul. 19, 2006 (TW) 095126395

(51) Int. Cl. H04B 7/00; H04M 1/00

(52) U.S. Cl. 455/41.2; 455/569.1

(57) ABSTRACT

The wireless communication apparatus includes a blue tooth wireless earphone that can be operated independently and a network phone base. The blue tooth wireless earphone is embedded into the network phone base. When the blue tooth wireless earphone is used independently, a voice is inputted and outputted via a microphone and a loudspeaker of the blue tooth wireless earphone, respectively. Once the blue tooth wireless earphone is used in combination with the network phone base, the voice is inputted and outputted via a microphone and a loudspeaker of the network phone base. The blue tooth wireless earphone is also used independently to be connected to a blue tooth mobile phone, a PDA, etc. Furthermore, by being connected to an external apparatus through a USB interface, the blue tooth wireless earphone is charged by the network phone base, and such a design is also applicable in a hands-free car earphone.

### CROSS-REFERENCE TO RELATED APPLICATIONS

This non-provisional application claims priority under 35 U.S.C. § 119(a) on Patent Application No(s). 095126395 filed in Taiwan, R.O.C. on Jul. 19, 2006, the entire contents of which are hereby incorporated by reference.

### BACKGROUND OF THE INVENTION

1. Field of Invention

The present invention relates to a wireless communication apparatus, and more particularly, to a blue tooth wireless earphone and a wireless network phone supported as an extension thereof.

2. Related Art

Generally, most of blue tooth wireless earphones in the market are suitable for all mobile phones and PDAs both having the function of a blue tooth earphone, and even are applicable in sonic equipments. Due to the advantages of light weight, a small volume, convenience in carrying, and a lively shape, the blue tooth wireless earphones become more and more popular with the users. The blue tooth wireless earphones can be connected to and communicated with mobile phones, PDAs, or sonic equipments via radio waves without physical connection, so as to provide the convenience in use for users.

A wireless communication apparatus, which supports both blue tooth VOIP network phones (for example, ICQ, MSN, Skype, and the like) and blue tooth wireless earphones, should not only provide all the functions of the blue tooth wireless earphones, but also have an LCD and a Key Pad, wherein the LCD is used for displaying all the necessary information and providing the operation of a user interface, and the Key Pad is used for selecting the functions, answering a phone call, providing numerical keys to make a local telephone call, etc. Such wireless communication apparatus (a blue tooth wireless earphone & a VOIP network phone) has a certain volume and weight; therefore, when going out, it is quite inconvenient for a blue tooth mobile phone to be connected to the wireless communication apparatus.

Moreover, users need longer conversation and stand-by time, so as to enjoy safe and convenient mobile communication life when walking, driving, or taking the MRT (Mass Rapid Transit). Therefore, in this case, how to design a blue tooth wireless earphone with light weight, a small volume, convenience in carrying, and high extensibility has become a key topic, wherein the blue tooth wireless earphone also can be disassembled as desired and can be used in combination with the VOIP network phone.

### SUMMARY OF THE INVENTION

In view of the above problems, the present invention provides a wireless communication apparatus comprising a blue tooth wireless earphone and a wireless network phone supported as an extension thereof. Such design is directed to solve the above problems. The wireless communication apparatus is constituted of a blue tooth wireless earphone that can be operated independently and a network phone base having a liquid crystal screen, a keyboard, a microphone, and a loudspeaker. The blue tooth wireless earphone is embedded into the network phone base, and provides an interface to control the liquid crystal screen, the keyboard entry, the microphone, and the loudspeaker of the network phone base. The blue tooth wireless earphone has a set of circuits therein to switch voices. When the blue tooth wireless earphone is used independently, a voice is inputted and outputted via the microphone and loudspeaker of the blue tooth wireless earphone. Once the blue tooth wireless earphone is used in combination with the network phone base, the voice is inputted and outputted via the microphone and loudspeaker of the network phone base.

When going out, the blue tooth wireless earphone can be used in connection with a blue tooth mobile phone, a PDA, and thus is the same as a common blue tooth wireless ear-hanging earphone. If necessary, the blue tooth wireless earphone can be used as a blue tooth network phone at home as long as being embedded into the network phone base.

Furthermore, when the power of the blue tooth wireless earphone is running low, by being connected to an external apparatus through a USB interface, the blue tooth wireless earphone is charged by the network phone base, and such a design is also applicable in a hands-free car earphone.

The detailed features and advantages will be described below in the detailed description in detail, those skilled in the art will understand the technology from the content and carry it out thereby, and according to the content, claims and drawings of the present specification, those skilled in the art will easily understand the objectives and advantages of the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

It is to be understood that, both the above description of the content of the present invention and the following detailed description intend to demonstrate and illustrate the principle of the invention, and to provide further explanation of the invention as claimed.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a wireless communication apparatus of the present invention;

FIG. 2A is a schematic view of combining the blue tooth wireless earphone and the network phone base of the present invention as a wireless communication apparatus to make a network phone call;

FIG. 2B is a schematic view of taking the blue tooth wireless earphone of the present invention as a hands-free apparatus of the blue tooth mobile phone; and

FIG. 3 is a block diagram of the system of one preferred embodiment of the present invention.

### DETAILED DESCRIPTION OF THE INVENTION

The features and practice of the preferred embodiment of the present invention will be illustrated below in detail with reference to the drawings.

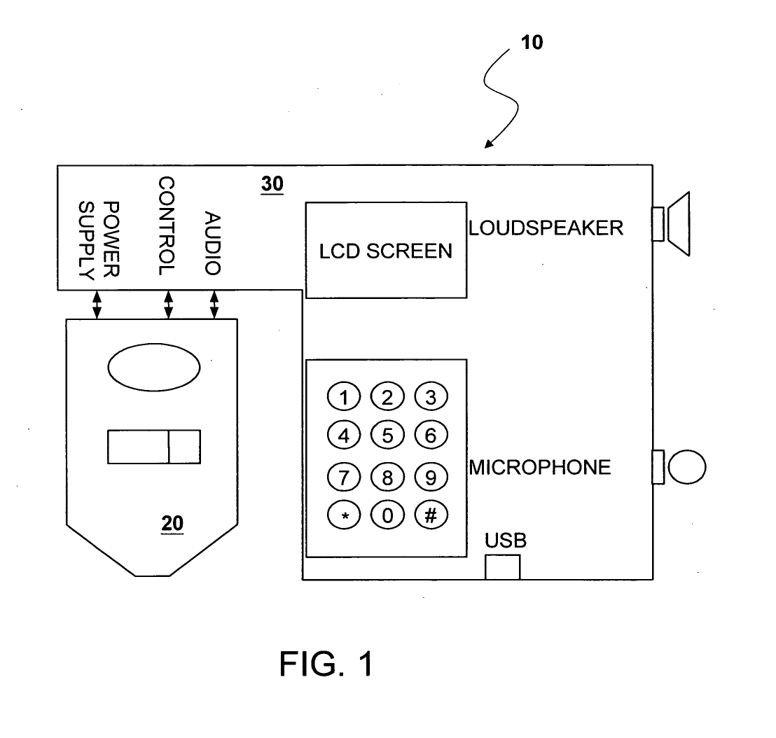

FIG. 1 is a schematic view of a wireless communication apparatus 10 according to the present invention. The present invention provides a wireless communication apparatus 10 comprising a blue tooth wireless earphone 20 and a network phone base 30. The wireless communication apparatus 10 is constituted of the blue tooth wireless earphone 20 that can be operated independently and the network phone base 30 having a liquid crystal screen, a keyboard, a microphone, and a loudspeaker. The blue tooth wireless earphone 20 is embedded into the network phone base 30, and provides an interface to control the liquid crystal screen, the keyboard entry, the microphone, and the loudspeaker of the network phone base 30.

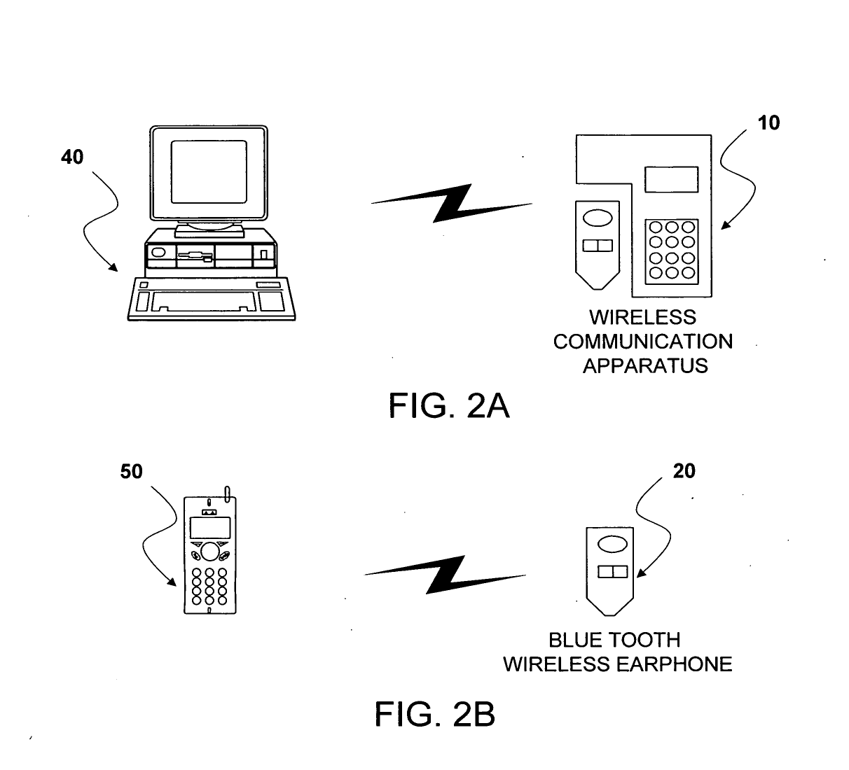

FIG. 2A is a schematic view of combining the blue tooth wireless earphone 20 and the network phone base 30 of the present invention as a wireless communication apparatus 10 to make a network phone call. After combination, the wireless communication apparatus 10 takes a blue tooth wireless communication protocol as a medium for making and answering a network phone call through a personal computer 40.

FIG. 2B is a schematic view of taking the blue tooth wireless earphone 20 of the present invention as a hands-free apparatus of the blue tooth mobile phone 50, which is also a conventional method.

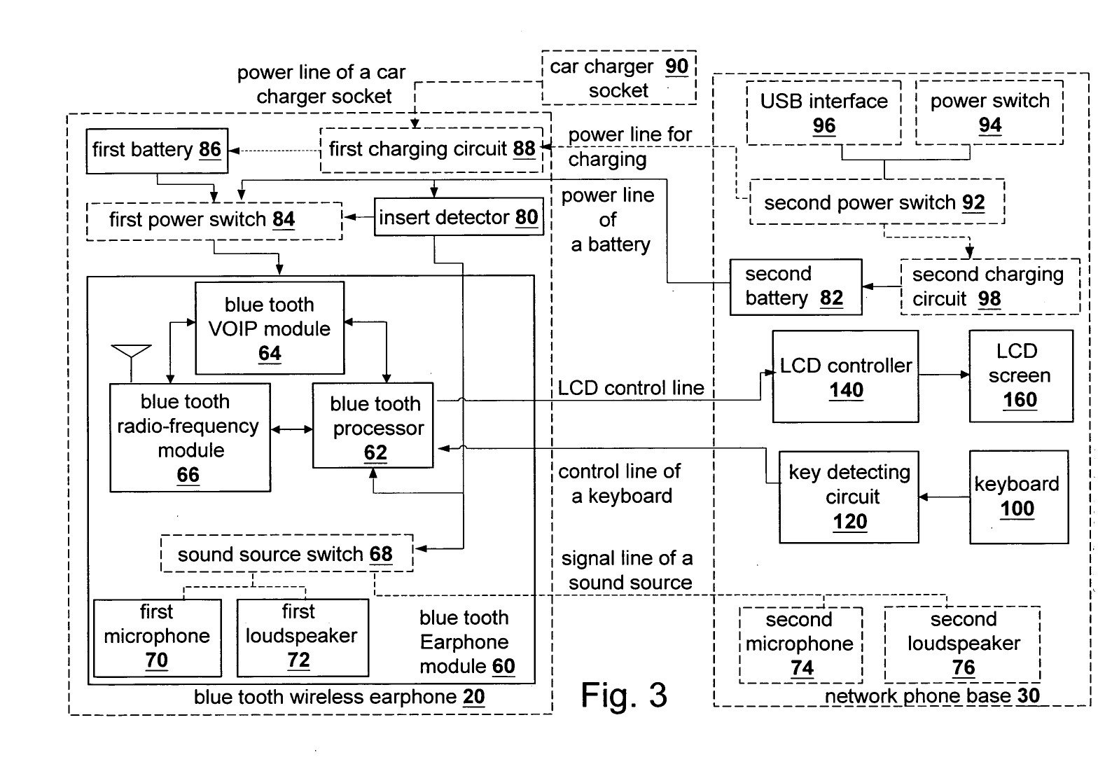

FIG. 3 is a block diagram of the system of one preferred embodiment of the present invention. In the preferred embodiment of the present invention, a wireless communication apparatus 10 comprises a blue tooth wireless earphone 20 and a network phone base 30, wherein the blue tooth wireless earphone 20 mainly comprises a blue tooth wireless earphone module 60. The blue tooth wireless earphone module 60 further comprises a blue tooth processor 62, wherein the blue tooth processor 62 further converts an audio signal into a digital signal through an analog-to-digital converter (not shown) and converts the digital signal into an original signal meeting a blue tooth communication specification. Then, a blue tooth VOIP module 64 converts the original signal and a signal meeting a VOIP specification into a baseband signal. It should be indicated specifically here that, when the blue tooth wireless earphone 20 is only used as the blue tooth earphone module 60, the blue tooth VOIP module 64 only converts the original signal into a baseband signal to be handled; and, when the blue tooth wireless earphone 20 extends the support to serve as the wireless communication apparatus 10, the blue tooth VOIP module 64 converts the original signal and a signal meeting the VOIP specification into a baseband signal. A blue tooth radio-frequency module 66 converts the baseband signal into a radio-frequency signal and transmits the radio-frequency signal to an external apparatus by means of wireless microwave. The external apparatus herein refers to, but is not limited to, the personal computer 40 or the blue tooth mobile phone 50 shown in FIGS. 2A and 2B. However, if not departing from the spirit and the scope of the present invention, other external apparatuses, such as sonic equipments, are all intended to be included within the scope of the present invention.

The blue tooth earphone module 60 of the present invention further comprises a sound source switch 68 therein for switching a voice inputted and outputted by the blue tooth wireless earphone 20 and the network phone base 30. When the blue tooth wireless earphone 20 is used independently, the voice is inputted or outputted via a first microphone 70 and a first loudspeaker 72 of the blue tooth earphone module 60. Once the blue tooth wireless earphone 20 is combined with the network phone base 30 to extend the support to serve as the wireless communication apparatus 10, the voice is selectively inputted and outputted via a second microphone 74 and a second loudspeaker 76 of the network phone base 30 according to a user's setting.

The blue tooth wireless earphone 20 of the present invention further comprises an insert detector 80, wherein the insert detector 80 is a circuit with a second battery 82 of the network phone 30 as an input, and controls both a first power switch 84 and the sound source switch 68.

When the blue tooth wireless earphone 20 is used individually, and the insert detector 80 does not detect the power inputted into the network phone base 30, the first battery 86 of the blue tooth wireless earphone 20 serves as a power supply, and the sound source is also outputted and inputted by the first microphone 70 and the first loudspeaker 72 of the blue tooth wireless earphone 20. The blue tooth wireless earphone 20 can be charged only through the first battery 86, and also can be charged by a car charger socket 90 or a second power switch 92 of the network phone base 30 through a first charging circuit 88. The power switch 92 can further be supplied with power from an external power supply through a power adapter 94 or a USB interface 96. Therefore, such blue tooth wireless earphone 20 combining with the network phone base 30 is the same as the independent blue tooth wireless earphone 20 and can be used as a hands-free apparatus of the blue tooth mobile phone 50 when going out, as shown in FIG. 2B.

The second battery 82 of the network phone base 30 is also charged through a second charging circuit 98.

When the blue tooth wireless earphone 20 is combined with the network phone base 30, the insert detector 80 detects the power input from the network phone base 30 and determines it as a VOIP mode, then the following processes are performed.

1. The battery capacity of the network phone base 30 is usually much larger than that of the blue tooth wireless earphone 20; thus, the first power switch 84 of the blue tooth wireless earphone 20 is switched to the second battery 82 of the network phone base 30 to supply power, and the second battery 82 of the network phone base 30 is used to save the power supplied by the first battery 86 of the blue tooth wireless earphone 20.

2. The sound source switch 68 can be switched to the second microphone 74 and the second loudspeaker 76 of the network phone base 30; however, this design is not necessary unless a sound amplification function is needed by the network phone base 30 or the mechanisms cannot interwork with each other when assembled together.

3. When detecting that the keyboard 100 of the network phone base 30 is pressed, a corresponding control reaction is performed by a press key detecting circuit 120. For example, when dialing or answering through the VOIP, the press key detecting circuit 120 is coupled to the blue tooth processor 62 through a keyboard control line and enables the blue tooth VOIP module 64.

4. The blue tooth processor 62 controls a LCD controller 140 of the network phone base 30 through a LCD control line, and displays the necessary information on a LCD screen 160 of the network phone base 30, so as to provide a user interface for users.

5. When the second battery 83 of the network phone base 30 is charged, the network phone base 30 charges the first battery 86 of the blue tooth wireless earphone 20 at the same time.

Besides the combination of the blue tooth wireless earphone 20 and the network phone base 30 described in the aforementioned preferred embodiment of the present invention, a blue tooth wireless earphone 20 for supporting the wireless network phone as an extension thereof, as shown in FIG. 3, also has an outstanding product added value, and besides the advantages of light weight, a small volume, convenience in carrying, a high extensibility, the blue tooth wireless earphone 20 for supporting the wireless network phone as an extension thereof further can be suitable for a common personal computer, a blue tooth mobile phone, and a sonic equipment. The blue tooth wireless earphone 20 comprises a first battery 86 functioning as a power supply when the blue tooth wireless earphone is independently used, a first microphone 70, a first loudspeaker 72, a blue tooth processor 62 for converting an audio signal into a digital signal through an analog-to-digital converter (not shown) and converting the digital signal into an original signal meeting a blue tooth communication specification, a blue tooth VOIP module 64 for converting the original signal or a signal meeting a VOIP specification into a baseband signal, a blue tooth radio-frequency module 66 for converting the baseband signal into a radio-frequency signal and transmitting the radio-frequency to an external apparatus by means of wireless microwave, a first power switch 84 being coupled to the first battery 86 and an external power supply, and an insert detector 80 for controlling the first power switch 84 and taking the external power as the power supply side of the blue tooth wireless earphone 20 when detecting an external power supply. Furthermore, the external power supply side comprises a power adapter 94 and a USB interface 96.

The blue tooth wireless earphone 20 further comprises a first charging circuit 88 for charging the first battery 86. The first charging circuit 88 is selectively charged from a car charger socket 90.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A wireless communication apparatus, comprising:
a blue tooth wireless earphone, comprising:
a first battery;
a first microphone;
a first loudspeaker;
a blue tooth processor for converting an audio signal into a digital signal through an analog-to-digital converter and converting the digital signal into an original signal corresponding to a blue tooth communication specification;
a blue tooth VOIP module for converting the original signal or a signal meeting a VOIP specification into a baseband signal; and
a blue tooth radio-frequency module for converting the baseband signal into a radio-frequency signal and transmitting the radio-frequency signal to an external apparatus by means of wireless microwave; and
a network phone base, comprising:
a second battery;
a keyboard;
an LCD screen;
a press key detecting circuit coupled to the blue tooth processor through a keyboard control line and enabling the blue tooth VOIP module; and
an LCD controller coupled to the press key detecting circuit and the blue tooth processor for displaying the necessary information on the LCD screen through an LCD control line;
wherein the blue tooth wireless earphone further comprises an insert detector for controlling a first power switch of the blue tooth wireless earphone and taking the second battery as a power supply when detecting the second battery.

2. The wireless communication apparatus as claimed in claim 1, wherein the insert detector controls a sound source switch to selectively input and output a voice via a second microphone and a second loudspeaker of the network phone base.

3. The wireless communication apparatus as claimed in claim 1, wherein the first power switch is coupled to the first battery and the second battery, respectively.

4. The wireless communication apparatus as claimed in claim 1, wherein the blue tooth wireless earphone further comprises a first charging circuit for charging the first battery.

5. The wireless communication apparatus as claimed in claim 4, wherein the first charging circuit is selectively charged from a car charger socket.

6. The wireless communication apparatus as claimed in claim 4, wherein the network phone base further comprises a second power switch coupled to the first charging circuit and the second charging circuit through the supply of an external power supply side.

7. The wireless communication apparatus as claimed in claim. 6, wherein the external power supply side comprises a power adapter or a USB interface.

8. The wireless communication apparatus as claimed in claim 1, wherein the network phone base further comprises a second charging circuit for charging the second battery.

9. The wireless communication apparatus as claimed in claim 8, wherein the network phone base further comprises a second power switch coupled to the first charging circuit and the second charging circuit through the supply of an external power supply side.

10. The wireless communication apparatus as claimed in claim 9, wherein the external power supply side comprises a power adapter or a USB interface.

11. The wireless communication apparatus as claimed in claim 1, wherein the external apparatus is a personal computer, a blue tooth mobile phone, or a sonic equipment.

12. A blue tooth wireless earphone for supporting a wireless network phone as an extension thereof, comprising:
a first battery functioning as a power supply when the blue tooth wireless earphone is independently used;
a first microphone;
a first loudspeaker;
a blue tooth processor for converting an audio signal into a digital signal through an analog-to-digital converter and converting the digital signal into an original signal meeting a blue tooth communication specification;
a blue tooth VOIP module for converting the original signal or a signal meeting a VOIP specification into a baseband signal;
a blue tooth radio-frequency module for converting the baseband signal into a radio-frequency signal and transmitting the radio-frequency signal to an external apparatus by means of wireless microwave;
a first power switch coupled to the first battery and an external power supply side; and
an insert detector for controlling the first power switch and taking the external power as a power supply side of the blue tooth wireless earphone when detecting the external power supply.

13. The blue tooth wireless earphone for supporting a wireless network phone as an extension thereof as claimed in claim 12, further comprising a first charging circuit for charging the first battery.

14. The blue tooth wireless earphone for supporting a wireless network phone as an extension thereof as claimed in claim 13, wherein the first charging circuit is selectively charged from a car charger socket.

15. The blue tooth wireless earphone for supporting a wireless network phone as an extension thereof as claimed in claim 12, wherein the external power supply side comprises a power adapter or a USB interface.

16. The blue tooth wireless earphone for supporting a wireless network phone as an extension thereof as claimed in claim 12, wherein the external apparatus is a personal computer, a blue tooth mobile phone, or a sonic equipment.
